(19) United States
(12) Patent Application Publication
(10) Pub. No.: US 2006/0138219 A1
(43) Pub. Date: Jun. 29, 2006

(54) Handset shopping tool and method thereof

(76) Inventors: John Brzezniak, Chicago, IL (US); Michael Irizarry, Algonquin, IL (US); Narothum Saxena, Hoffman Estates, IL (US)

Correspondence Address: SIDLEY AUSTIN LLP, 717 NORTH HARWOOD, SUITE 3400, DALLAS, TX, 75201, US

(21) Appl. No.: 11/024,920

(22) Filed: Dec. 29, 2004

(51) Int. Cl. G06K 15/00; G07F 7/00

(52) U.S. Cl. 235/383; 705/27

(57) ABSTRACT

A system and method for facilitating shopping which can be used to allow a shopper to perform price comparison for a product. Product information can be entered and transmitted to a server, along with location information. Based on the shopper's location, the system and method can advantageously provide the shopper with the identity and/or location of on-line stores and nearby physical stores that carry the product.

### FIELD OF THE INVENTION

The present invention relates generally to communication systems, and more particularly to a system and method using a communications system for facilitating shopping.

### BACKGROUND OF THE INVENTION

Traditionally, a shopper goes from store to store, looking for products to purchase. Once a desired product is found in a store, the shopper could either purchase the product from that store or, alternatively, the shopper could go to a second store to determine whether the second store offers the same product at a lower price. Depending on the product desired, the second store may or may not carry the product, may carry the product but not have it in stock, or may charge a higher or lower price for the product. If the second store does not carry the product, does not have the product in stock, or charges a higher price, the shopper could return to the first store to make the purchase.

A shopper in search of a particular product could also telephone (e.g., from the shopper's home) a number of stores in an attempt to locate a store carrying the desired product and request pricing and availability information for the product prior to visiting the store.

More recently, systems have been developed to allow shopping to be performed on-line via a communications network such as the Internet. A shopper can use, e.g., a computer, to view an on-line store's web site. An on-line shopper can search for the desired product on a number of web sites and can compare pricing and availability information from each of the web sites prior to purchasing the product.

While product searching and price comparison can be more readily performed on-line, shopping at a physical store has certain advantages, such as the ability to see and touch an actual product, and to immediately obtain the product. However, a shopper at a physical store is disadvantaged in that price comparisons cannot be readily performed while the shopper is at the store.

Accordingly, there is a need for a system and method for facilitating shopping. The system and method can be advantageously employed by a shopper in performing price comparison. Further, the system and method can assist the shopper in locating a product at another store, either an on-line store, or a physical store near the shopper's location.

### SUMMARY OF THE INVENTION

A system and method for facilitating shopping is described herein. The system and method can be used to allow a shopper to perform price comparison for a product. The price comparison can be performed in real time, e.g., while the shopper is at a store. Thus, the shopper need not return home to determine pricing and availability of the product at other stores by either telephoning the other stores, or by visiting the web sites of on-line stores. Further, based on the shopper's location, the system and method can advantageously provide the shopper with the identity and/or location of nearby stores that carry the product. The system and method can provide the shopper with a list of stores which currently have the product in stock, or alternatively, can provide the shopper with a full list of stores that carry the product, along with availability information.

One embodiment of the invention employs a communications device having data entry capability to allow product information (e.g., a unique product identifier) to be entered and transmitted to a server. The communications device is also capable of transmitting location information to the server. In a related embodiment, the location information can be entered by the shopper or can be determined based on the location of the communications device. Upon reception of product and location information, the server can search, e.g., an on-line database and/or a local database associated with one or more on-line and/or physical stores, to determine pricing and availability information for the product from the various on-line and/or local stores. The collected information can be sorted and/or filtered, based on the location information, and transmitted to the communications device. In a related embodiment, the collected information can also be sorted solely based on price and transmitted to the communications device. The information can then be provided to the shopper by the communications device.

One embodiment of the invention employs a communications device having picture taking capability to allow a picture of at least a portion of a product, e.g., the UPC (Universal Product Code), to be taken and transmitted to a server. Another embodiment of the invention employs a communications device having scanning capability to allow a UPC code of a product to be scanned and transmitted to the server. Yet another embodiment of the invention employs a communications device having radio frequency identification (RFID) reception capability (e.g., an RFID reader) to allow an identification of a product to be read and transmitted to the server. The communications device is also capable of transmitting location information to the server. In a related embodiment, the location information can be entered by the shopper or can be determined based on the location of the communications device. Upon reception of location information and product information (e.g., the picture of the UPC code, data scanned by the barcode scanner, data read by the RFID reader), the server can extract product information (e.g., a unique product identifier) from the picture or data. The server can search, e.g., an on-line database and/or a local database associated with one or more on-line and/or physical stores, to determine pricing and availability information for the product from the various on-line and/or local stores. The collected information can be sorted and/or filtered, based on the location information, and transmitted to the communications device. In a related embodiment, the collected information can also be sorted solely based on price and transmitted to the communications device. The information can then be provided to the shopper by the communications device.

One embodiment of the invention is a method for facilitating shopping. The method comprises receiving, from a communications device, product information relating to a product and location information relating to a location of a shopper, searching, based on the product information, a database associated with at least one on-line store or physical store, for pricing information for the product, sorting the information based on at least the location information, and transmitting the sorted information to the communications device.

One embodiment of the invention is a method for facilitating shopping. The method comprises receiving, from a communications device, information relating to a product (e.g., a picture of at least a portion of a product such as the UPC code, data scanned by a barcode scanner, data read by an RFID reader) and location information relating to a location of a shopper, extracting product information (e.g., a unique product identifier) from the picture or data, searching, based on the product information, a database associated with at least one on-line store or physical store, for pricing information for the product, sorting the information based on at least the location information, and transmitting the sorted information to the communications device.

### BRIEF DESCRIPTION OF THE DRAWINGS

A more complete understanding of the present invention and its advantages will be readily apparent from the following Detailed Description taken in conjunction with the accompanying drawings. Throughout the accompanying drawings, like parts are designated by like reference numbers and in which:

FIG. 1 is a schematic illustration of a communications network in accordance with the present invention;

FIG. 2 is a flow diagram illustrating a process for facilitating shopping in accordance with an embodiment of the present invention; and

FIG. 3 is a flow diagram illustrating a process for facilitating shopping in accordance with another embodiment of the present invention.

### DETAILED DESCRIPTION

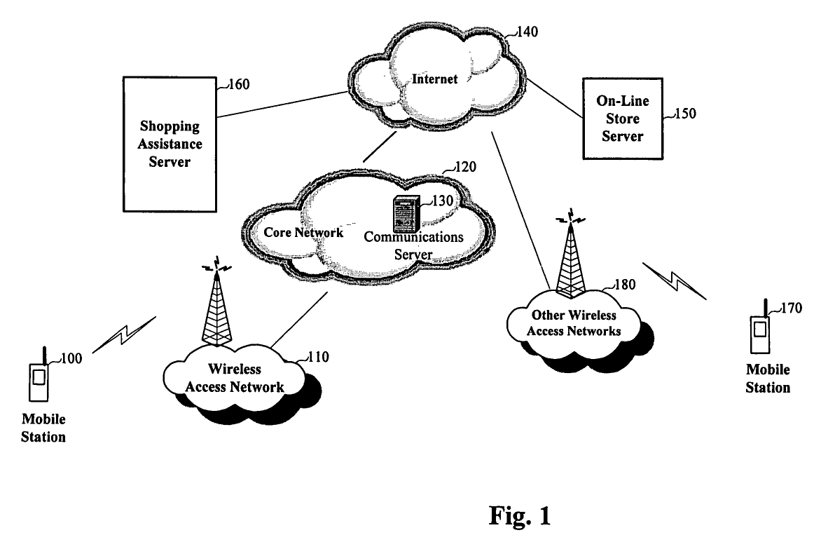

FIG. 1 schematically illustrates a representative environment of the present invention. A first communications device (mobile station 100) is wirelessly connected to a first wireless access network 110 via a first radio frequency (RF) network. In one embodiment, the first communications device is a wireless data capable handset such as a cellular telephone that is capable of transmitting and receiving data in addition to voice calling capability. Another example of a communications device is a personal digital assistant (PDA) which has data communications capability but which may or may not have voice calling capability.

In one embodiment, the communications device includes camera capability to allow pictures to be taken. The picture can be stored for later use, and/or transmitted via the first wireless access network 110. In another embodiment, the communications device includes scanning capability (e.g., barcode scanner) to allow, e.g., a UPC code of a product to be scanned. In yet another embodiment, the communications device includes radio frequency identification reception capability (e.g., an RFID reader) to allow an identification of a product to be read. In one embodiment, the mobile station 100 includes or has access to data from a positioning system. For example, a global positioning system (GPS) may be built-in or connected to the mobile station 100 to provide the mobile station 100 with location information. Alternatively, location information can be obtained from a location based service (LBS) in which the location of one or more cellular towers or base stations can be used to determine the location of the mobile station 100 (e.g., by triangulation, measuring signal strength, etc.).

The first wireless access network 110 is configured for receiving data from and transmitting data to one or more mobile stations 100. The first wireless access network 110 is connected to a core network 120, including a communications server 130, typically via a wire-line. The core network 120 is connected to a communications network (e.g., the Internet) 140.

A number of computer systems are connected to the communications network 140. For example, an on-line store may operate a web site using one or more servers 150 connected to the communications network 140. A shopping assistance server 160 is connected (directly or indirectly) to the communications network 140 and can communicate with the first mobile station 100 via the first wireless access network 110. The shopping assistance server 160 may be a computer system including one or more server computers, personal computers, etc.

A second mobile station 170 is wirelessly connected to a second wireless access network 180 via a second radio frequency network. The second radio frequency network can utilize the same or a different type of wireless access technology as the first radio frequency network. For example, in one embodiment, the first radio frequency network can utilize cdma2000 while the second radio frequency network can utilize another type of wireless access technology such as WiFi, etc. The second wireless access network 180 is connected to the communications network 140 via a number of intermediate devices (not shown) to allow the second mobile station 170 to communicate with the first mobile station 100 and with the shopping assistance server 160 via the communications network 140.

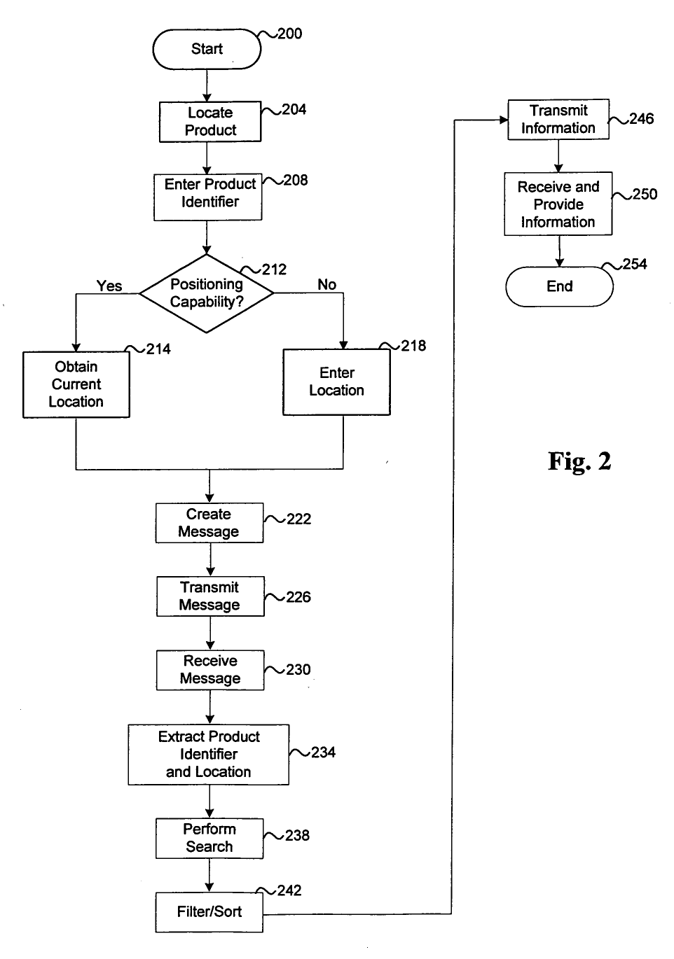

FIG. 2 illustrates a flow diagram of a process for facilitating shopping in accordance with an embodiment of the present invention. The process allows a shopper, using a mobile station (such as mobile station 100 or 170), to perform price comparison for a product. The price comparison can be performed in real time, e.g., while the shopper is at a store. Thus, the shopper need not return home to determine pricing and availability of the product at other stores by either telephoning the other stores, or by visiting on-line stores.

The process starts at step 200. In step 204, the shopper locates a product that the shopper would like to purchase (or perform a price check or price comparison on). The shopper could be at a local retail store, or any other location in which the shopper has access to the actual product. In a related embodiment, the shopper need not have access to the actual product, but need only have access to a unique product identifier for the product such as the product's UPC code (either the actual UPC barcode from the product packaging, or simply the UPC code number).

The mobile station 100 includes an application that is capable of sending and receiving information to and from a server (e.g., via a data connection to the server). In one embodiment, the application is capable of sending and receiving text. In a related embodiment, the application is capable of sending and receiving pictures and text and/or multimedia content to and from a server. In another embodiment, the application is a multimedia message system (MMS) client that is capable of sending and receiving MMS messages. In one embodiment, the application is a separate application from a server application receiving the data. In another embodiment, the application includes a portion running on the mobile station 100 and another portion running on the server.

In step 208, the shopper launches the application (or the MMS client) and enters the unique product identifier into the application. In one embodiment, the shopper uses a keypad of the mobile station 100 to enter the UPC code number of the product. In another embodiment, the shopper uses the keypad of the mobile station 100 to enter the brand name, model name and/or model number of the product.

In step 212, the application determines whether the mobile station 100 includes or has access to a positioning system such as a global positioning system (GPS) which may be built-in or connected to the mobile station 100, or other location based service (LBS) in which the location of one or more cellular towers or base stations can be used to determine the location of the mobile station 100 (e.g., by triangulation or otherwise). If so, (Yes in step 212), the application obtains the current location of the mobile station 100 from the positioning system in step 214. The application may obtain the location of the mobile station 100 by communicating with the GPS system, or alternatively, the application may request the location information from the communications network 140.

If not, (No in step 212), the application prompts the shopper to enter the location of the shopper in step 218. In one embodiment, the application prompts the shopper to enter a zip code (or other location information, such as city/state information) corresponding to the shopper's current location. In another embodiment, the application prompts the shopper to enter a zip code (or other location information) corresponding to an area in which the shopper would like to shop. In a related embodiment in which the mobile station includes positioning capability, the application allows the shopper to override the current location as determined by the positioning system and to enter another location (e.g., corresponding to an area in which the shopper would like to shop).

In step 222, the application creates a message for transmitting to the shopping assistance server 160. The message can be transmitted, for example, over the cellular data network. In one embodiment, the message includes at least the unique product identifier and the location. Of course, in other embodiment, the unique product identifier and the location information can be transmitted in separate messages. In step 226, the application transmits the message or messages, containing the unique product identifier and the location information, to the shopping assistance server 160.

In one embodiment, the shopping assistance server 160 is a computer or network of computers connected to the communications network 140. The computer or computers forming the shopping assistance server 160 can be one or more of any combination of personal computers, servers, mainframe computers, supercomputers, etc. In one embodiment, the shopping assistance server 160 includes one or more applications running on one or more computers connected to the communications network 140. In a related embodiment an application associated with the shopping assistance server 160 may include a client portion running on the mobile station 100, and a server portion running on another computer. The shopping assistance server 160 of the present invention may be implemented in software running on standard computer hardware, specialized computer hardware, or any combination thereof.

In one embodiment, the shopping assistance server 160 includes a shopping assistance application having an input module for receiving the product identifier and location information. In step 230, the shopping assistance server 160 (or the input module of the shopping assistance application) receives the message or messages containing the unique product identifier and the location information. Then, in step 234, the shopping assistance server 160 extracts the unique product identifier and the location information from the message or messages.

In one embodiment, the shopping assistance application includes a search module. In step 238, the shopping assistance server 160 (or the search module of the shopping assistance application) performs one or more searches on the unique product identifier. In one embodiment, the shopping assistance server 160 searches on-line shopping sites for the product corresponding to the unique product identifier. A physical store or chain of stores may also operate a web site which provides product and pricing information. In one embodiment, the shopping assistance server 160 can search the web site(s) of the physical store for the product. In a related embodiment, the shopping assistance server 160 can search the web site(s) of the store for one or more store locations proximate the received location information (e.g., the shopper's location). In another embodiment, the shopping assistance server 160 can search a database containing product and pricing information available from on-line and/or local stores. The shopping assistance server 160 can search any suitable database (e.g., any UPC database) to find the actual product. The shopping assistance server 160 can thus determine the prices of the product from the various on-line and local stores.

In one embodiment in which the unique product identifier is a UPC code, the shopping assistance server 160 can perform a search on the UPC code in a first database to find the product. Then, the shopping assistance server 160 can perform a second search to find pricing and availability information for the product from various on-line and local stores.

In one embodiment, the shopping assistance application includes a location module for determining a geographical location associated with the shopper based on the location information. In one embodiment, the shopping assistance application includes a reporting module. In step 242, the shopping assistance server 160 (or the reporting module) sorts or filters the pricing information based on the proximity of a physical store to the received location information. In one embodiment, the information can be filtered such that the shopper can be provided with a list of stores within the geographic area of the shopper that have the product, along with the price of the product. In another embodiment, the shopper can be provided with a list of stores having the product, sorted based on the store's proximity to the received location information (e.g., the shopper's location, the zip code entered, or the location of the mobile station 100). In a related embodiment, the information can be sorted first based on location, and then based on price. In another related embodiment, the information can be sorted based solely on price (regardless of whether the store is an on-line store or a physical store). In one embodiment, the shopper can be provided with a separate list of on-line stores that have the product along with the price of the product. Information relating to the on-line stores can also be provided to the shopper in the same listing as information relating to the physical stores.

In step 246, the shopping assistance server 160 creates a message containing the sorted and/or filtered search results and transmits the sorted and/or filtered information to the mobile station 100. In one embodiment, in which the mobile station 100 is a cellular telephone, the information is transmitted to the mobile station 100 via a cellular data network. In step 250, the application on the mobile station 100 receives the information from the shopping assistance server 160 and provides the information to the shopper. In one embodiment, the application can notify the shopper by providing a distinctive ring tone or other notification when it receives the information from the server. The shopper can then view the information on the mobile station 100.

In another embodiment, if the product identifier provided by the shopper is not a unique product identifier, the shopping assistance server 160 can gather pricing information on all products that match the product identifier provided, or alternatively, the shopping assistance server 160 can communicate with the shopper via the application and request more information from the shopper. The process then ends at step 254.

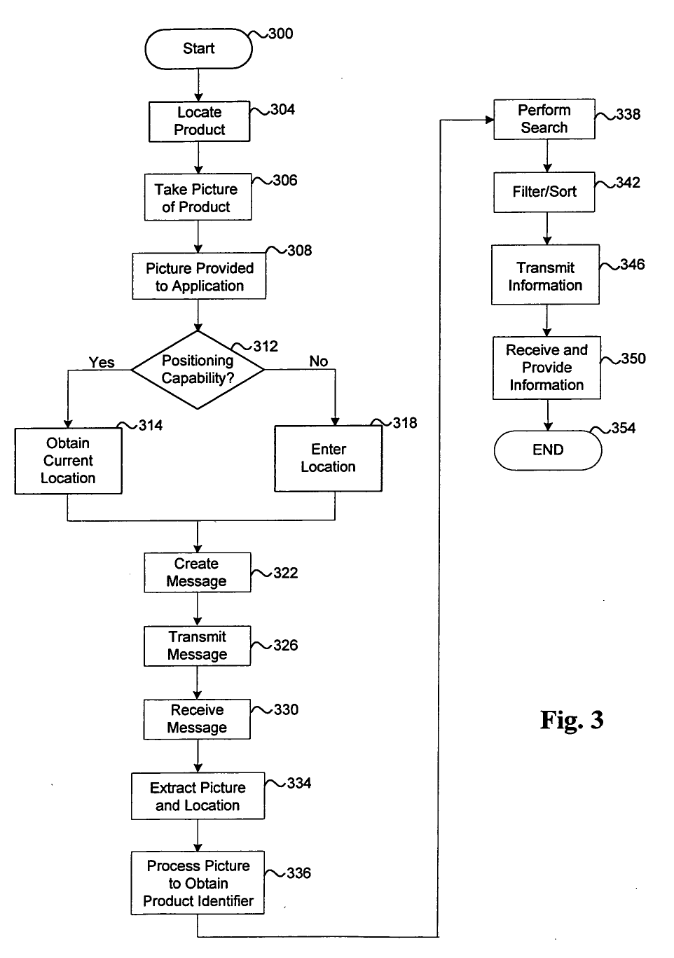

FIG. 3 illustrates a flow diagram of a process for facilitating shopping in accordance with an embodiment of the present invention. The process starts at step 300. In step 304, the shopper locates a product that the shopper would like to purchase (or perform a price check or price comparison on). The shopper could be at a local retail store, or any other location in which the shopper has access to the actual product. In a related embodiment, the shopper need not have access to the actual product, but need only have access to a picture of a unique product identifier for the product such as the product's UPC barcode or RFID tag from the product packaging.

In one embodiment, the mobile station 100 includes camera capability to allow pictures to be taken. In another embodiment, the mobile station 100 does not include camera capability, but is capable of obtaining pictures from another device. For example, the mobile station 100 may be configured to communicate with another device with camera capability to receive the picture. In another embodiment, the mobile station 100 includes scanning capability (e.g., a barcode scanner) to allow a UPC code of a product to be scanned. In yet another embodiment, the mobile station 100 includes radio frequency identification capability (e.g., an RFID reader) to allow an RFID tag of a product to be read. In step 306, the shopper locates and takes a picture of the unique product identifier of the product (e.g., a UPC code or barcode symbol) if the mobile station 100 includes camera capability. The shopper can load a picture of the unique product identifier of the product (e.g., from another device) if the mobile station 100 does not include camera capability, or if the shopper does not have access to the product. Alternatively, the shopper can scan the UPC code of the product if the mobile station 100 includes barcode scanning capability, or the shopper can read the RFID tag of the product if the mobile station 100 includes RFID reception capability.

The mobile station 100 includes an application that is capable of sending and receiving information to and from a server. In one embodiment, the application is capable of sending and receiving pictures and text and/or multimedia content to and from a server. In another embodiment, the application is a MMS client that is capable of sending and receiving MMS messages. In one embodiment, the application is a separate application from a server application receiving the data. In another embodiment, the application includes a portion running on the mobile station 100 and another portion running on the server.

In step 308, the picture of the unique product identifier of the product is provided to the application. In an alternative embodiment, the shopper can launch the application (or the MMS client) and use the application to take a picture of the unique product identifier of the product. In another embodiment, the shopper can launch an application and use the corresponding data entry device (e.g., barcode scanner, RFID reader) to obtain product data.

In step 312, the application determines whether the mobile station 100 includes or has access to a positioning system such as a global positioning system which may be built-in or connected to the mobile station 100, or other location based service in which the location of one or more cellular towers or base stations can be used to determine the location of the mobile station 100 (e.g., by triangulation or otherwise). If so, (Yes in step 312), the application obtains the current location of the mobile station 100 from the positioning system in step 314. The application may obtain the location of the mobile station 100 by communicating with the GPS system, or alternatively, the application may request the location information from the communications network 140.

If not, (No in step 312), the application prompts the shopper to enter the location of the shopper in step 318. In one embodiment, the application prompts the shopper to enter a zip code (or other location information, such as city/state information) corresponding to the shopper's current location. In another embodiment, the application prompts the shopper to enter a zip code (or other location information) corresponding to an area in which the shopper would like to shop. In a related embodiment in which the mobile station includes positioning capability, the application allows the shopper to override the current location as determined by the positioning system and to enter another location (e.g., corresponding to an area in which the shopper would like to shop).

In step 322, the application creates a message for transmitting to the shopping assistance server 160. The message can be transmitted, for example, over the cellular data network. In one embodiment, the message includes product information (e.g., a picture of the unique product identifier, data scanned by the barcode scanner, data read by the RFID reader) and the location. In another embodiment, the product information and the location information can be transmitted in separate messages. In step 326, the application transmits the message or messages containing the product information and the location information to the shopping assistance server 160.

In one embodiment, the shopping assistance server 160 includes a shopping assistance application having an input module for receiving the product identifier and location information. In step 330, the shopping assistance server 160 (or the input module of the shopping assistance application) receives the message or messages containing the product information (e.g., picture of the UPC code, data scanned by the barcode scanner, data read by the RFID reader) and the location information. Then, in step 334, the shopping assistance server 160 extracts the product information and the location information from the message or messages.

In one embodiment, the application includes a picture processing module. In step 336, the shopping assistance server 160 (or the picture processing module) processes the picture of the unique product identifier to obtain a unique product identifier for the product. In one embodiment in which the picture is a picture of a UPC code, the shopping assistance server 160 processes the picture of the UPC code to obtain the UPC code number (e.g., by using barcode scanning software). In another embodiment in which the picture is a picture of the packaging containing a brand name and a product name, the shopping assistance server 160 processes the picture to obtain the brand name and product name of the product (e.g., by using optical character recognition (OCR)). In another embodiment, the application includes a module for processing data provided by a barcode scanner. In yet another embodiment, the application includes a module for processing data provided by an RFID reader. In either case, the shopping assistance server 160 processes the data provided to obtain a unique product identifier for the product.

In one embodiment, the shopping assistance application includes a search module. In step 338, the shopping assistance server 160 (or the search module) performs one or more searches on the unique product identifier. In one embodiment, the shopping assistance server 160 searches on-line shopping sites for the product corresponding to the unique product identifier. In one embodiment, the shopping assistance server 160 can search the web site(s) of physical store(s) for the product. In a related embodiment the shopping assistance server 160 can search the web site(s) of the physical store(s) for one or more store locations proximate the received location information (e.g., the shopper's location). In another embodiment, the shopping assistance server 160 can search a database containing product and pricing information available from on-line and/or local stores. The shopping assistance server 160 can search any suitable database (e.g., any UPC database) to find the actual product. The shopping assistance server 160 can thus determine the prices of the product from the various on-line and local stores.

In one embodiment in which the unique product identifier is a UPC code, the shopping assistance server 160 can perform a search on the UPC code in a first database to find the product. Then, the shopping assistance server 160 can perform a second search to find pricing and availability information for the product from various on-line and local stores.

In one embodiment, the shopping assistance application includes a location module for determining a geographical location associated with the shopper based on the location information. In one embodiment, the shopping assistance application includes a reporting module. In step 342, the shopping assistance server 160 (or the reporting module) sorts or filters the pricing information based on the proximity of a physical store to the received location information. In one embodiment, the information can be filtered such that the shopper can be provided with a list of stores in the geographic area of the shopper that have the product, along with the price of the product. In another embodiment, the shopper can be provided with a list of stores having the product, sorted based on the store's proximity to the received location information (e.g., the shopper's location, the zip code entered, or the location of the mobile station 100). In a related embodiment, the information can be sorted first based on location, and then based on price. In another related embodiment, the information can be sorted based solely on price (regardless of whether the store is an on-line store or a physical store). In one embodiment, the shopper can be provided with a separate list of on-line stores that have the product along with the price of the product. Information relating to the on-line stores can also be provided to the shopper in the same listing as information relating to the physical stores.

In step 346, the shopping assistance server 160 creates a message containing the sorted and/or filtered search results and transmits the sorted and/or filtered information to the mobile station 100. In one embodiment, in which the mobile station 100 is a cellular telephone, the information is transmitted to the mobile station 100 via a cellular data network. In step 350, the application on the mobile station 100 receives the information from the shopping assistance server 160 and provides the information to the shopper. In one embodiment, the application can notify the shopper by providing a distinctive ring tone or other notification when it receives the information from the server. The shopper can then view the information on the mobile station 100.

In another embodiment, if the product identifier provided by the shopper is not a unique product identifier, the shopping assistance server 160 can gather pricing information on all products that match the product identifier provided, or alternatively, the shopping assistance server 160 can communicate with the shopper via the application and request more information from the shopper. The process then ends at step 354.

While the above processes were described with respect to a single product, in other embodiments the application can allow the shopper to enter information relating to a plurality of products for price comparison. Additionally, while the processes described above provide price comparison, the shopper can use the process simply to locate a product at a nearby store.

By using the location of the shopper, the present invention can provide the shopper with pricing data that is relevant to the shopper. The shopper can then make a decision as to whether the shopper should purchase the product from an on-line store, or from a local store. Additionally, if the shopper chooses to purchase the product from a local store, the present invention can provide the shopper with pricing information for one or more stores in the same geographic area as the shopper. Further, by providing the shopper with the ability to override the positioning system in the mobile station 100 (if one exists), the present invention allows the shopper to plan a shopping trip in advance. For example, if the shopper will be at a certain location in the near future and wishes to purchase the product at a store in that geographical are, the shopper can input that location and have the pricing information sorted or filtered based on that location.

Although the present invention has been fully described by way of examples and with reference to the accompanying drawings, it is to be understood that various changes and modifications will be apparent to those skilled in the art without departing from the spirit and scope of the invention. Therefore, unless such changes and modifications depart from the scope of the present invention, they should be construed as being included therein.

What is claimed is:

1. A method, performed by a computer, for facilitating shopping, comprising:
receiving, from a communications device, product information relating to a product and location information relating to a location of a shopper;
searching, based on the product information, at least one database associated with at least one on-line store or physical store for pricing information associated with the product;
sorting the pricing information based on at least the location information; and
transmitting the sorted pricing information to the communications device.

2. A method in accordance with claim 1, wherein the product information is a UPC code, the step of searching further comprising:
searching a database for a product name associated with the UPC code; and
searching the plurality of on-line stores or physical stores for pricing information associated with the product name.

3. A method in accordance with claim 1, further comprising:
determining a geographic area of the shopper based on the location information; and
filtering the pricing information to eliminate pricing information corresponding to physical stores located outside of the geographic area of the shopper.

4. A method in accordance with claim 1, further comprising:
sorting the pricing information based solely on price; and
transmitting the pricing information sorted based solely on price to the communications device.

5. A method, performed by a computer, for facilitating shopping, comprising:
receiving, from a communications device, product information obtained from at least a portion of a product, and location information relating to a location of a shopper;
processing the product information to obtain a product identifier for the product;
searching, based on the product identifier, at least one database associated with at least one on-line store or physical store for pricing information associated with the product;
sorting the pricing information based on at least the location information; and
transmitting the sorted pricing information to the communications device.

6. A method in accordance with claim 5, wherein the product information is selected from the group consisting of:
a picture of at least a portion of the product;
a picture of a UPC code;
data scanned by a barcode scanner; and
data read by an RFID reader.

7. A method in accordance with claim 5, wherein the product identifier is a UPC code, the step of searching further comprising:
searching a database for a product name associated with the UPC code; and
searching the plurality of on-line stores or physical stores for pricing information associated with the product name.

8. A method in accordance with claim 5, further comprising
determining a geographical area of the shopper based on the location information; and
filtering the pricing information to eliminate pricing information corresponding to physical stores located outside of the geographical area of the shopper.

9. A method in accordance with claim 5, further comprising:
sorting the pricing information based solely on price; and
transmitting the pricing information sorted based solely on price to the communications device.

10. A system for facilitating shopping, comprising:
a communications network;
a communications device, connected to the communications network, having an input device for receiving product information relating to a product and location information relating to a location of a user, and a data transmission device for transmitting the product information and the location information; and
a computer, connected to the communications device via the communications network and having a shopping assistance application adapted for running thereon, the application having an input module adapted to receive the product information and the location information from the communications device, a search module adapted to search at least one database associated with at least one on-line store or physical store for pricing information associated with the product, and a reporting module adapted to sort the pricing information based on at least the location information and to provide the sorted pricing information for transmission to the communications device.

11. A system in accordance with claim 10, wherein the communications device includes a global positioning system for generating the location information.

12. A system in accordance with claim 10, wherein the location information is provided to the communications device by the communications network.

13. A system in accordance with claim 10, wherein the input device includes a camera for taking a picture of a product identifier, the product information including the picture of the product identifier, and the application further includes a picture processing module for processing the picture to obtain the product identifier.

14. A system in accordance with claim 13, wherein the picture of the product identifier is a picture of a UPC code, the search module further comprising a UPC search module for searching a database for a product name associated with the UPC code.

15. A system in accordance with claim 10, wherein the input device includes a barcode scanner for scanning a product identifier, the product information including the data scanned by the barcode scanner, and the application further includes a scanner processing module for processing the scanned data to obtain the product identifier.

16. A system in accordance with claim 10, wherein the input device includes an RFID reader for reading an RFID tag, the product information including the data read by the RFID reader, and the application further includes an RFID processing module for processing the data read to obtain the product identifier.

17. A system in accordance with claim 10, wherein the application further comprises a location module for determining a geographic area of the shopper based on the location information, the reporting module further adapted to filter the pricing information to eliminate pricing information corresponding to physical stores located outside of the geographic area of the shopper.

18. A system in accordance with claim 10, wherein the reporting module is further adapted to sort the pricing information based solely on price and to provide the pricing information sorted based solely on price for transmission to the communications device.

19. A computer recording medium including computer executable code capable of being run on a computer, the computer recording medium comprising:
computer executable code for receiving product information obtained from at least a portion of a product and location information relating to a location of a shopper;
computer executable code for processing the product information to obtain a product identifier for the product;
computer executable code for searching, based on the product identifier, at least one database associated with at least one on-line store or physical store for pricing information associated with the product;
computer executable code for sorting the pricing information based on at least the location information; and
computer executable code for providing the sorted pricing information for transmission to the communications device.

20. A computer recording medium including computer executable code capable of being run on a computer in accordance with claim 19, wherein the product information is selected from the group consisting of:
a picture;
a picture of a UPC code;
data scanned by a barcode scanner; and
data read by an RFID reader.

21. A computer recording medium including computer executable code capable of being run on a computer in accordance with claim 19, wherein the product identifier is a UPC code, the computer executable code for searching further comprising:
computer executable code for searching a database for a product name associated with the UPC code; and
computer executable code for searching the plurality of on-line stores or physical stores for pricing information associated with the product name.

22. A computer recording medium including computer executable code capable of being run on a computer in accordance with claim 19, further comprising:
computer executable code for determining a geographical area of the shopper based on the location information; and
computer executable code for filtering the pricing information to eliminate pricing information corresponding to physical stores located outside of the geographical area of the shopper.

23. A computer recording medium including computer executable code capable of being run on a computer in accordance with claim 19, further comprising:
computer executable code for sorting the pricing information based solely on price; and
computer executable code for providing the pricing information sorted based solely on price for transmission to the communications device.
